(19) United States
(12) Patent Application Publication
(10) Pub. No.: US 2002/0078359 A1
(43) Pub. Date: Jun. 20, 2002

(54) Apparatus for embedding and detecting watermark and method thereof

(76) Inventors: Jong Won Seok, Taejon (KR); Jin Woo Hong, Taejon (KR)

Correspondence Address: JACOBSON HOLMAN, PLLC., PROFESSIONAL LIMTED LIABILITY COMPANY, 400 Seventh Street, N.W., Washington, DC, 20004, US

(21) Appl. No.: 09/995,704

(22) Filed: Nov. 29, 2001

(30) Foreign Application Priority Data
Dec. 18, 2000 (KR) 2000-77645

(51) Int. Cl. H04L 9/00

(52) U.S. Cl. 713/176

(57) ABSTRACT

The present invention utilizes a linear prediction analysis for embedding a watermark into a digital audio signal and further use a short-time autocorrelation for detecting the watermark from a watermarked audio signal. A watermark-embedding apparatus includes a delayer, a linear prediction analysis filter, a linear prediction analyzer, a linear prediction synthesis filter, a sign generator and an error correction encoder. A watermark-detecting apparatus includes a linear prediction analyzer, a linear prediction analysis filter, a short-time autocorrelation part, a sign detector and an error correction decoder.

### FIELD OF THE INVENTION

The present invention relates to an apparatus for embedding and detecting an watermark; and, more particularly, to an apparatus for embedding/detecting the watermark having copyright information into/from a digital audio signal and a method thereof, wherein the watermark is embedded into the audio signal by virtue of a linear prediction analysis and the copyright information is extracted from a watermarked audio signal using a short-time autocorrelation.

### DESCRIPTION OF THE PRIOR ART

In recent years, as a computer network such as internet and a use of a computer are enormously increased, a digital multimedia is generally used and popularized. However, the digital multimedia is easily duplicated due to its own characteristic so that everybody can access and copy the digital data with ease through piracy. Therefore, demands for the data piracy protection and protecting the copyright and an ownership of creators are severely required nowadays.

Up to now, a data encoding method has been widely used as a copyright protection method. From this method, it is impossible to access the data providing that a person does not know a code. But if the person knows the code, the digital data may be duplicated unlimitedly and distributed illegally.

In order to overcome the above problem, there is proposed a method for embedding a watermark into the multimedia data. The digital watermark technique is a kind of copyright protection techniques that an invisible copyright signal is embedded into the multimedia and subsequently the watermark is extracted from the watermarked multimedia. Although the watermark can be embedded into the multimedia like a visible logo-type, it is more preferable to use the invisible typed watermark because the watermark may be deleted easily and the quality of the multimedia may be deteriorated in case of using the visible watermark. Therefore, researches for embedding the invisible watermark into the multimedia have been advanced recently.

In case of embedding the invisible watermark into the multimedia, there are several required conditions as followings. First, the embedded watermark must be perceptually invisible. That is, a picture quality of the original multimedia is not deteriorated due to the insertion of the watermark. Even if the picture quality may be deteriorated, degrees of deterioration should be trivial. Second, the watermark is robust to distortions applied to the multimedia. In other words, the watermark is so robust not to be deleted at all though intentional attacks are launched thereto. Third, the watermark is not ambiguous, which means that the watermark should have the property to clarify whose watermark is embedded into the multimedia. Namely, there should be no misconception about the authenticity of the watermark.

However, in accordance with the conventional copyright protection methods for the digital audio data using the watermark, there is a drawback that the quality of the audio data is deteriorated after embedding the watermark thereinto. In addition, it is impossible to extract the watermark from the watermarked audio data in case that an arbitrary attack such as compressing, filtering or the like is launched to the watermarked audio signal. In particular, the conventional watermark-embedding and watermark-extracting methods are based on a spread-spectrum technique which is often utilized in a code division multiple access (CDMA) communication. The conventional method using the spread-spectrum technique has the disadvantage that it is impossible to detect the watermark if the time-scale attack is launched thereto because a pseudonoise sequence is utilized as the watermark signal.

### SUMMARY OF THE INVENTION

It is, therefore, an object of the present invention to provide an apparatus for embedding a watermark into a digital audio signal by using a linear prediction analysis.

It is, therefore, another object of the present invention to provide an apparatus for detecting the watermark from a watermarked audio signal incorporating therein a copyright information by using a short-time autocorrelation.

It is, therefore, further another object of the present invention to provide a method for embedding a watermark into a digital audio signal by using a linear prediction analysis.

It is, therefore, still further another object of the present invention to provide a method for detecting the watermark from a watermarked audio signal incorporating therein a copyright information by using a short-time autocorrelation.

In accordance with one aspect of the present invention, there is provided an apparatus for embedding a watermark into an original audio signal, comprising: a linear prediction analysis means for generating a prediction coefficient of the original audio signal by means of a linear prediction analysis after the original audio has been inputted thereto; a residual signal output means for outputting a residual signal of a delayed original audio signal by filtering the delayed original audio signal using the prediction coefficient generated from the linear prediction analysis means; an echo signal generation means for generating an echo signal of the original audio signal by synthesizing the prediction coefficient of the original audio signal and the residual signal of the delayed required audio signal; and a copyright information insertion means for generating a watermarked audio signal by combining the original audio signal and the echo signal of the original audio signal having copyright information therein.

In accordance with another aspect of the present invention, there is provided an apparatus for detecting a watermark from a watermarked audio signal using an echo signal of a delayed original audio that is delayed for a predetermined delay time (τ), the apparatus comprising: a linear prediction analysis means for generating a prediction coefficient by means of the linear prediction analysis of the watermarked audio signal; a linear prediction analysis filter for outputting a residual signal by eliminating an inherent spectrum of the original audio signal after filtering the watermarked audio signal using the prediction coefficient;

a short-time autocorrelation means for calculating an autocorrelation using the residual signal outputted from the linear prediction analysis filter; and a sign detection means for detecting the copyright information after detecting a sign of the value outputted from the short-time autocorrelation means.

In accordance with further another aspect of the present invention, there is provided a method for embedding a watermark into an original audio signal, the method comprising the steps of: a) generating a prediction coefficient of the original audio signal by means of the linear prediction analysis; b) outputting a residual signal of a delayed audio by filtering the delayed original audio signal and eliminating an inherent spectrum of the audio signal, using the prediction coefficient of the original audio signal; c) outputting a synthesis signal by using the prediction coefficient of the original audio signal and the residual signal of the delayed original audio signal; d) granting an error correction function to the copyright information; e) assigning a sign to the synthesis signal after an error corrected copyright information is inputted thereto; and f) outputting a watermarked audio signal by adding the original audio signal and the synthesis signal that a predetermined sign has been assigned.

In accordance with still further another aspect of the present invention, there is provided a method for detecting a watermark from a watermarked audio signal using a residual signal of a delayed original audio signal that is delayed for a predetermined delay time (τ), the method comprising the steps of: a) generating a prediction coefficient by means of a linear prediction analysis of the watermarked audio signal; b) outputting a residual signal by eliminating an inherent spectrum of the audio signal after filtering the watermarked audio signal using the prediction coefficient; c) calculating an autocorrelation using the residual signal; and d) detecting the copyright information after detecting a sign of the value outputted from the short-time autocorrelation means.

### BRIEF DESCRIPTION OF THE DRAWINGS

The above and other objects and features of the present invention will become apparent from the following description of the preferred embodiment given in conjunction with the accompanying drawings, in which:

FIG. 1 is a block diagram setting forth an apparatus for embedding and detecting a watermark in accordance with a preferred embodiment of the present invention;

FIG. 2 is a block diagram illustrating a watermark-embedding unit in detail in accordance with the present invention; and

FIG. 3 is a block diagram representing a watermark-detecting unit in detail in accordance with the present invention.

### DETAILED DESCRIPTION OF THE PREFERRED EMBODIMENTS

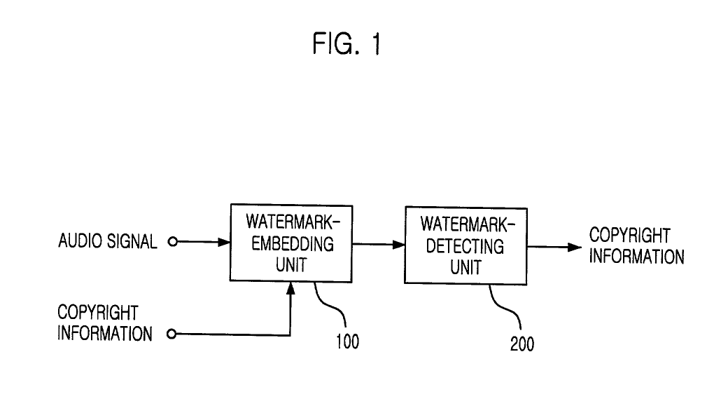

Referring to FIG. 1, there is shown a block diagram setting forth an apparatus for embedding and detecting a watermark in accordance with a preferred embodiment of the present invention. The inventive apparatus comprises a watermark-embedding unit 100 and a watermark-detecting unit 200. The watermark-embedding unit 100 plays a role in embedding the watermark into an original audio signal after the original audio signal and copyright information of the original audio signal are inputted thereto. The watermark-detecting unit 200 plays a role in extracting copyright information from a watermarked audio signal outputted from the watermark-embedding unit 100.

Copyright information data are embedded into the original audio signal inputted to the watermark-embedding unit 100 repeatedly at a fixed time interval. Here, an imbedded amount of the data can be controlled by adjusting a magnitude of a section of the audio signal that the copyright information is embedded thereinto. In addition, the copyright information to be embedded in the audio or a video signal may be image data, video data, audio data, sound data, a text or the like.

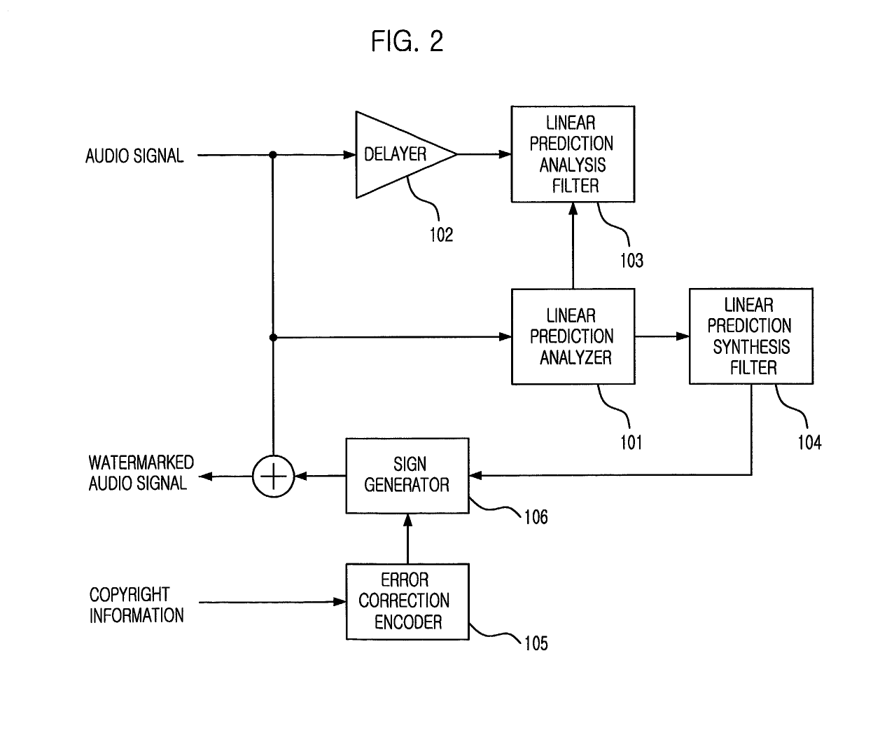

Referring to FIG. 2, there is a block diagram setting forth the watermark-embedding unit 100 in detail in accordance with the present invention. The watermark-embedding unit 100 includes a linear prediction analyzer 101, a delayer 102, a linear prediction analysis filter 103, a linear prediction synthesis filter 104, an error correction encoder 105 and a sign generator 106.

The original audio signal in inputted into the linear prediction analyzer 101 so that predetermined p number of prediction coefficients, i.e., a₁, a₂, . . . , aₚ, are generated by virtue of a linear prediction analysis. The prediction coefficients p range from 5 to 50 but they can be varied by a state of the inputted original audio signal. That is, the linear prediction analyzer 101 plays a role in generating the predetermined p number of the prediction coefficients which are able to predict the inputted audio signal through the linear prediction analysis. At this time, by utilizing the prediction coefficients, it is possible to predict an inherent spectrum of the inputted original audio signal.

Meanwhile, the original audio signal is inputted into the delayer 102 also. The original audio signal is delayed for a predetermined time (τ, referred to a delay time hereinafter) and a delayed audio signal is outputted to the linear prediction analysis filter 103. It is noted that the delay time (τ) is a key to detect the watermark.

The linear prediction analysis filter 103 plays a role in filtering the delayed audio signal using the prediction coefficients. Namely, the inputted audio signal is filtered using the prediction coefficient to estimate the inherent spectrum of the audio signal so that a residual signal or an error signal, in which the inherent spectrum of the audio signal is eliminated, may be outputted.

The linear prediction synthesis filter 104 outputs a synthesis audio signal after the prediction coefficient outputted from the linear prediction analyzer 101 and the residual signal outputted from the linear prediction analysis filter 103, are inputted thereto. In other words, by utilizing the prediction coefficient corresponding to the inherent spectrum of the original audio signal and the residual signal of the delayed original audio signal, the synthesis audio signal is generated and inputted into the sign generator 106. The copyright information is inputted into the sign generator 106 through the error correction encoder 105. The error correction encoder 105 plays a role in granting an error correction function, whereby the error that may be generated in detecting a watermark signal can be corrected.

The sign generator 106 assigns a sign to the synthesis audio signal generated from the linear prediction synthesis filter 104. That is, if an output value of an error-corrected copyright information outputted from the error correction encoder 105 is 0, the sign becomes a negative. If the output value of an error-corrected copyright information is 1, the sign becomes a positive. In case of assigning the minus sign to the synthesis audio signal, the synthesis audio signal outputted from the linear prediction synthesis filter 104 is subtracted from the original audio signal. On the contrary with this, in case of assigning the positive sign to the synthesis audio signal, the synthesis audio signal outputted from the linear prediction synthesis filter 104 is added to the original audio signal. Therefore, a watermarked audio signal having the copyright information therein, is generated at last.

In conclusion, after the original audio signal is delayed for the delay time (τ) while passing through the linear prediction analysis and the synthesis steps, the synthesis audio signal is generated using the residual signal of the delayed original audio signal and the prediction coefficient corresponding to the inherent spectrum of the original audio signal. As a result, an echo signal that is delayed for the delay time (τ), is utilized as the watermark.

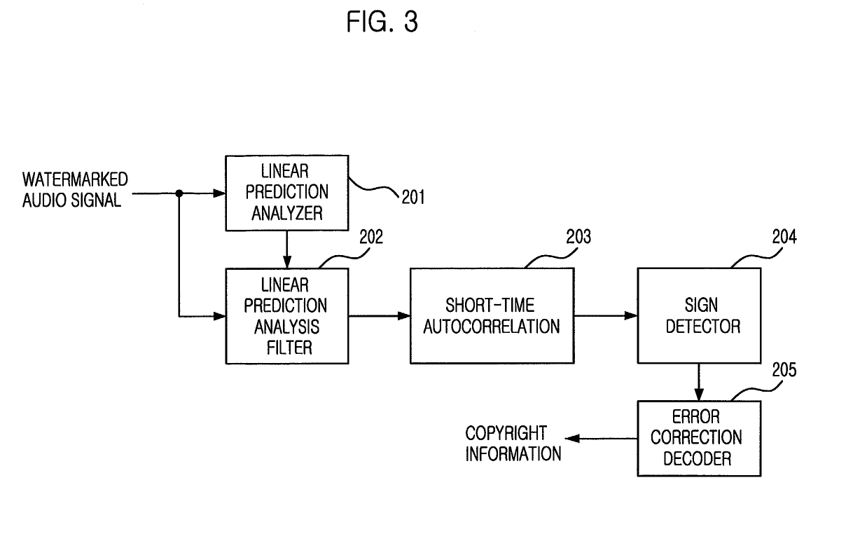

Referring to FIG. 3, there is a block diagram setting forth the watermark-detecting unit 200 in detail in accordance with the present invention. The watermark-detecting unit 200 includes a linear prediction analyzer 201, a linear prediction analysis filter 202, a short-time autocorrelation part 203, a sign detector 204 and an error correction decoder 205.

The watermarked audio signal is inputted into the linear prediction analyzer 201. As a similar manner to the linear prediction analyzer 101 of the watermark-embedding unit 100, the linear prediction analyzer 201 outputs predetermined p number of prediction coefficients, i.e., a₁, a₂, . . . , aₚ, by virtue of the linear prediction analysis.

The linear prediction analysis filter 202 plays a same role to the linear prediction analysis filter 103 of the watermark-embedding unit 100. That is, the linear prediction analysis filter 202 generates a filtered residual signal or an error signal in which the spectrum of the watermarked audio signal is eliminated. Here, an outputted residual signal is a combined signal of the residual signal of the original audio signal and the residual signal of the delayed original audio signal which is delayed for the delay time (τ). The outputted residual signal is inputted into the short-time autocorrelation part 203, wherein autocorrelation of the inputted signal is calculated. As aforementioned, since the inputted signal is the combined signal of the residual signal of the original audio signal and the residual signal of the delayed original audio signal, the measurement for the autocorrelation property results in representing a highest value at an origin or at the delay time (τ).

The sign detector 204 investigates the sign of the autocorrelation at τ measured in the short-time autocorrelation part 203. Thereafter, if the sign is positive, an output value becomes 1 and if the sign is negative, the output value becomes 0. Subsequently, the resultant output value, i.e., 0 or 1, is inputted into the error correction decoder 205 which outputs an error corrected copyright information through an error-correction decoding step after the resultant output sign detected from the sign detector 204 is inputted thereinto. Therefore, the output of the error correction decoder 205 becomes a final copyright information.

As described already, the apparatus for embedding and detecting watermark and the method thereof have several advantages as followings: first, it is possible to utilized the inventive apparatus and method as a copyright protection technique effectively; second, the watermark can be embedded into the audio signal without deteriorating the quality of the audio signal; third, the watermark is detected stably although an arbitrary attack such as compression, time-scale attack and filtering is launched thereinto; fourth, the present invention can be available for authentication to confirm the concoction or deformation of the digital audio signal; fifth, the present invention can be used suitably for a usage control to control an allowable duplication time by means of the watermark when the digital data is played through a potable device or an audio device; and sixth, it is also possible to transmit a supplementary data by using the watermark.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for embedding a watermark into an original audio signal, comprising:
a linear prediction analysis means for generating a prediction coefficient of the original audio signal by means of a linear prediction analysis after the original audio has been inputted thereto;
a residual signal output means for outputting a residual signal of a delayed original audio signal by filtering the delayed original audio signal using the prediction coefficient generated from the linear prediction analysis means;
an echo signal generation means for generating an echo signal of the original audio signal by synthesizing the prediction coefficient of the original audio signal and the residual signal of the delayed required audio signal; and
a copyright information insertion means for generating a watermarked audio signal by combining the original audio signal and the echo signal of the original audio signal having copyright information therein.

2. The apparatus as recited in claim 1, wherein the linear prediction analysis means generates the prediction coefficient which is able to predict an inherent spectrum of the audio by virtue of the linear prediction analysis.

3. The apparatus as recited in claim 1, wherein the residual signal output means includes:
a delay means for delaying the original signal for a predetermined delay time (τ); and
a linear prediction analysis filter for outputting the residual signal by eliminating the inherent spectrum of the delayed original audio signal after filtering the delayed original audio signal using the prediction coefficient.

4. The apparatus as recited in claim 3, wherein the predetermined delay time (τ) is a detection key of the watermark.

5. The apparatus as recited in claim 1, wherein the echo signal generation means is a linear prediction synthesis filter for outputting the echo signal of the original audio signal by synthesizing the prediction coefficient of the original audio signal outputted from the linear prediction analysis means and the residual signal of the delayed original audio signal outputted from the residual signal output means.

6. The apparatus as recited in claim 1, wherein the copyright information insertion means includes:
an error correction encoder for granting an error correction function to the copyright information embedded into the original audio signal;
a sign generator for assigning a sign to the echo signal of the original audio signal outputted from the echo signal generation means according to an error-corrected copyright information outputted from the error correction encoder; and
a summer for outputting a watermarked audio signal by adding a sign-assigned signal outputted from the sign generator and the original audio signal.

7. The apparatus as recited in claim 6, wherein the error correction encoder outputs each different value, i.e., 0 or 1, according to the copyright information, the sign generator assigns a positive sign or a negative sign to the echo signal of the original audio signal and the summer outputs the watermarked audio signal having the copyright information therein by adding the echo signal to the original audio signal or subtracting the echo signal from the original audio signal.

8. A method for embedding a watermark into an original audio signal, the method comprising the steps of:
a) generating a prediction coefficient of the original audio signal by means of the linear prediction analysis;
b) outputting a residual signal of a delayed audio by filtering the delayed original audio signal and eliminating an inherent spectrum of the audio signal, using the prediction coefficient of the original audio signal;
c) outputting a synthesis signal by using the prediction coefficient of the original audio signal and the residual signal of the delayed original audio signal;
d) granting an error correction function to the copyright information;
e) assigning a sign to the synthesis signal after an error corrected copyright information is inputted thereto; and
f) outputting a watermarked audio signal by adding the original audio signal and the synthesis signal that a predetermined sign has been assigned.

9. An apparatus for detecting a watermark from a watermarked audio signal using an echo signal of a delayed original audio that is delayed for a predetermined delay time (τ), the apparatus comprising:
a linear prediction analysis means for generating a prediction coefficient by means of the linear prediction analysis of the watermarked audio signal;
a linear prediction analysis filter for outputting a residual signal by eliminating an inherent spectrum of the original audio signal after filtering the watermarked audio signal using the prediction coefficient;
a short-time autocorrelation means for calculating an autocorrelation using the residual signal outputted from the linear prediction analysis filter; and
a sign detection means for detecting the copyright information after detecting a sign of the value outputted from the short-time autocorrelation means.

10. The apparatus as recited in claim 9, further includes an error correction decoder for outputting the error-corrected copyright information through an error-correction decoding step after the resultant output sign detected from the sign detector 204 is inputted thereinto.

11. The apparatus as recited in claim 9, wherein the linear prediction analysis means generates the residual signal in which the residual signal of the original audio signal and the residual signal of the delayed original signal.

12. The apparatus as recited in claim 11, wherein the short-time autocorrelation means finds out the residual signal of the original audio signal and the residual signal of the delayed original audio signal by calculating the autocorrelation of the residual signal.

13. The apparatus as recited in claim 11, wherein the sign detection means investigates a correlation sign of the residual signal of the original audio signal and the residual signal of the delayed original signal, thereby outputting an output value, i.e., 0 or 1, according the correlation sign.

14. A method for detecting a watermark from a watermarked audio signal using a residual signal of a delayed original audio signal that is delayed for a predetermined delay time (τ), the method comprising the steps of:
a) generating a prediction coefficient by means of a linear prediction analysis of the watermarked audio signal;
b) outputting a residual signal by eliminating an inherent spectrum of the audio signal after filtering the watermarked audio signal using the prediction coefficient;
c) calculating an autocorrelation using the residual signal; and
d) detecting the copyright information after detecting a sign of the value outputted from the short-time autocorrelation means.
